(19) United States
(12) Patent Application Publication
(10) Pub. No.: US 2025/0104409 A1
(43) Pub. Date: Mar. 27, 2025

(54) METHODS AND SYSTEMS FOR FUSING MULTI-MODAL SENSOR DATA

(71) Applicant: Toyota Motor Engineering & Manufacturing North America, Inc., Plano, TX (US)

(72) Inventors: Qi Chen, San Jose, CA (US); Hongsheng Lu, San Jose, CA (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/371,623

(22) Filed: Sep. 22, 2023

(51) Int. Cl. G06V 10/80; G06T 3/40; G06T 19/00; G06V 10/24; G06V 10/77; G06V 20/56

(52) U.S. Cl. CPC G06V 10/806; G06T 3/40; G06T 19/00; G06V 10/24; G06V 10/7715; G06V 20/56; G06T 2200/04; G06T 2219/021

(57) ABSTRACT

A method of fusing multi-modal sensor data is provided. The method includes obtaining features for 3D data captured by a first sensor of an ego vehicle, obtaining features for images captured by second sensors of the ego vehicle, flattening the features for 3D data to first features in bird eye view, transforming the features for images into second features in bird eye view, concatenating the first features and the second features to obtain first concatenated multi-sensor features, and fusing the first concatenated multi-sensor features with second concatenated multi-sensor features received from another vehicle to obtain fused multi-sensor features.

### TECHNICAL FIELD

The present specification relates to systems and methods for fusing multi-modal sensor data, and more particularly, fusing features of multi-modal sensor data of an ego vehicle with features of multi-modal sensor data of a remote vehicle.

### BACKGROUND

Cooperative perception refers to an idea where a vehicle uses its local perceptual data and neighboring vehicles' sensing data (e.g., RGB data, Lidar data, radar data) to understand surrounding environment.

In a conventional system, an ego vehicle receives raw sensing data from another vehicle, and processes the data to extract features and obtains predictions based on the extracted features. However, it is challenging to send the huge amount of raw sensing data in real time from one vehicle to another. In another conventional system, an ego vehicle receives prediction results from another vehicle and combines the prediction results of the ego vehicle with the prediction results from another vehicle to obtain final results. However, for this type of sensor fusion system to benefit the ego vehicle, an object needs to be detected by either another vehicle or the ego vehicle, or both. Due to the limitation of detection systems, there will be scenarios where an object is not detected by any of the connected vehicles, which leads to degradation in detection accuracy. Thus, this may decrease the detection accuracy.

Accordingly, a need exists for providing a method and system for cooperative perception among multiple vehicles with reduced data communication but with reliable accuracy.

### SUMMARY

The present disclosure provides systems and methods for cooperative perception by fusing features of multi-modal sensor data of an ego vehicle with features of multi-modal sensor data of a remote vehicle.

In one embodiment, a method of fusing multi-modal sensor data is provided. The method includes obtaining features for 3D data captured by a first sensor of an ego vehicle, obtaining features for images captured by second sensors of the ego vehicle, flattening the features for 3D data to first features in bird eye view, transforming the features for images into second features in bird eye view, concatenating the first features and the second features to obtain first concatenated multi-sensor features, and fusing the first concatenated multi-sensor features with second concatenated multi-sensor features received from another vehicle to obtain fused multi-sensor features.

In another embodiment, a system for fusing multi-modal sensor data is provided. The system includes a vehicle comprising a processor programmed to perform: obtaining features for 3D data captured by a first sensor of an ego vehicle, obtaining features for images captured by second sensors of the ego vehicle, flattening the features for 3D data to first features in bird eye view, transforming the features for images into second features in bird eye view, concatenating the first features and the second features to obtain first concatenated multi-sensor features, and fusing the first concatenated multi-sensor features with second concatenated multi-sensor features received from another vehicle to obtain fused multi-sensor features.

In yet another embodiment, a non-transitory computer readable medium storing instructions is provided. The instructions, when executed by a processor, cause the processor to perform: obtaining features for 3D data captured by a first sensor of an ego vehicle, obtaining features for images captured by second sensors of the ego vehicle, flattening the features for 3D data to first features in bird eye view, transforming the features for images into second features in bird eye view, concatenating the first features and the second features to obtain first concatenated multi-sensor features, and fusing the first concatenated multi-sensor features with second concatenated multi-sensor features received from another vehicle to obtain fused multi-sensor features.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1A schematically depicts a system for cooperative perception, according to one or more embodiments shown and described herein;

FIG. 1B illustrates difference between the data fusion of the present disclosure and the conventional data fusion;

FIG. 2 schematically depicts a system for cooperative perception using intermediate fusion, according to one or more embodiments shown and described herein;

FIG. 3 depicts an overall process for fusing features from a plurality of vehicles, according to one or more embodiments shown and described herein;

FIG. 4 depicts the overall process of fusing features of multi-modal sensors, according to one or more embodiments shown and described herein;

FIG. 5 depicts details of an encoder that is used by an ego vehicle and another vehicle, according to one or more embodiments shown and described herein; and

FIG. 6 depicts details of fusing two concatenated multi-sensor features by a fusion network, according to one or more embodiments shown and described herein.

### DETAILED DESCRIPTION

The embodiments disclosed herein include systems and methods for cooperative perception by fusing features of multi-modal sensor data of an ego vehicle with features of multi-modal sensor data of a remote vehicle.

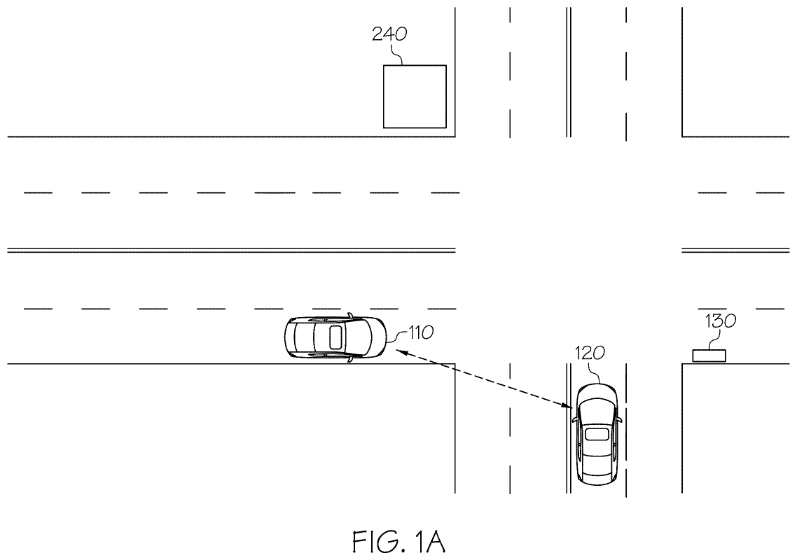

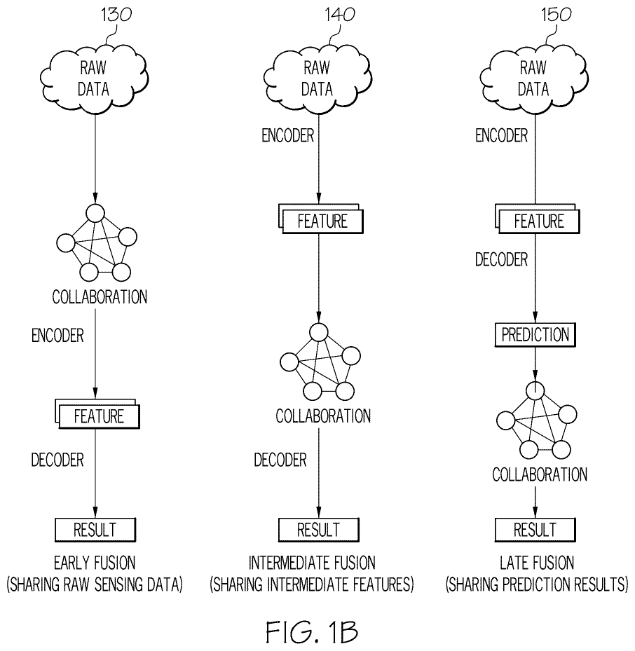

In order to address the issues in the conventional systems, the present disclosure utilizes intermediate fusion, or feature-based collaboration as illustrated in FIG. 1B. According to the present system, a remote vehicle transmits its features extracted from its raw sensing data to an ego vehicle, and the ego vehicle fuses the features of the ego vehicle and the features of the remote vehicle. Then, the ego vehicle obtains detection results based on the fused multi-sensor features. Because each vehicle routinely extracts features out of raw data locally and the features are intermediate produce of object detection networks, the present system does not require additional computation overhead when implementing the intermediate fusion. In addition, the present system does not require raw sensing data transmission, but retains information about raw data by communicating features that are extracted by encoders. Thus, the present system provides good balance between detection accuracy and transmission bandwidth.

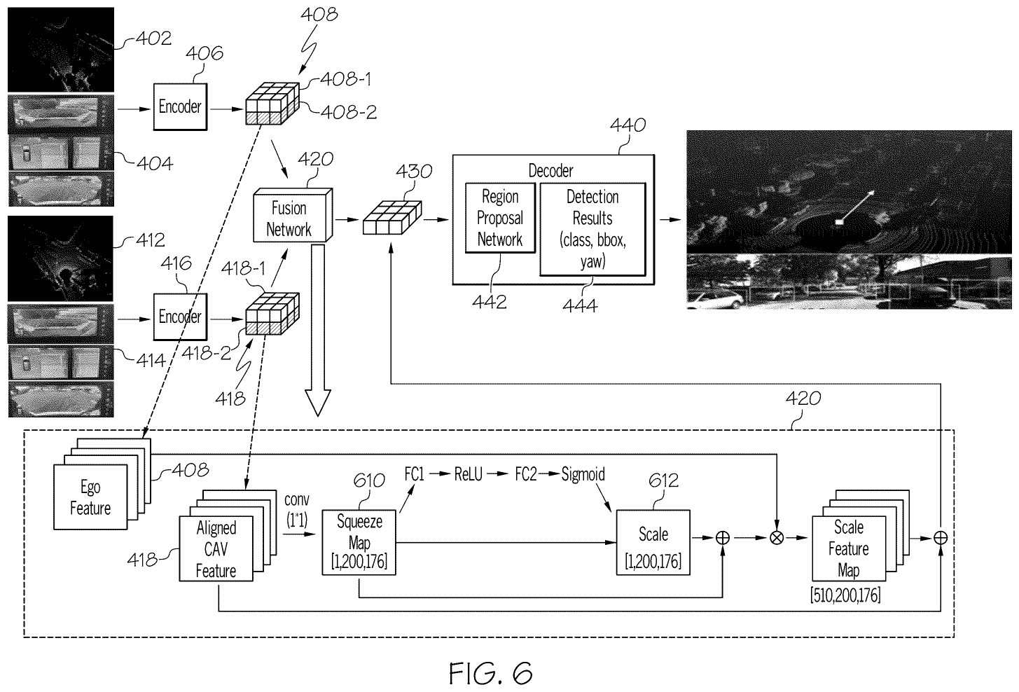

In addition, the scale-fusion network of the present system, which will be described below with reference to FIG. 6, allows the network to fuse better features shared by surrounding vehicles with the ego vehicle's local features. The superior performance comes from the careful design in the architecture of scale-fusion.

FIG. 1A schematically depicts a system for cooperative perception, according to one or more embodiments shown and described herein. In embodiments, a system includes first and second connected vehicles 110 and 120. The first and second connected vehicles 110 and 120 may cooperatively perceive external objects such as an object 130. The first and second connected vehicles 110 and 120 may directly communicate with each other without an intervening entity. In some embodiments, the first and second connected vehicles 110 and 120 may communicate with a server 240. The server 240 may be a local server including, but not limited to, roadside unit, an edge server, and the like. In some embodiments, the server 240 may be a remote server such as a cloud server.

Each of the first and second connected vehicles 110 and 120 may be a vehicle including an automobile or any other passenger or non-passenger vehicle such as, for example, a terrestrial, aquatic, and/or airborne vehicle. In some embodiments, one or more of the first and second connected vehicles 110 and 120 may be an unmanned aerial vehicle (UAV), commonly known as a drone.

The first and second connected vehicles 110 and 120 may be autonomous and connected vehicles, each of which navigates its environment with limited human input or without human input. The first and second connected vehicles 110 and 120 are equipped with internet access and share data with other devices both inside and outside the first and second connected vehicles 110 and 120. Each of the first and second connected vehicles 110 and 120 may include an actuator such as an engine, a motor, and the like to drive the vehicle. In some embodiments, the first and second connected vehicles 110 and 120 may communicate with the server 240. The server 240 may communicate with vehicles in an area covered by the server 240. The server 240 may communicate with other servers that cover different areas. The server 240 may communicate with a remote server and transmit information collected by the server 240 to the remote server.

In FIG. 1A, the first connected vehicle 110 and the second connected vehicle 120 are encountering the same scene with different perspectives. As illustrated in FIG. 1A, the first connected vehicle 110 and the second connected vehicle 120 may approach an intersection from different directions. The first connected vehicle 110 may be a vehicle that views an intersection, road boundaries, static objects such as trees, building, traffic lights, and moving objects such as other vehicles. The second connected vehicle 120 may be another vehicle or a remote vehicle that may also view an intersection, road boundaries, static objects such as trees, building, traffic lights, and moving objects such as other vehicles. However, the pose of the first connected vehicle 110, i.e., the location and orientation of the first connected vehicle 110 is different from the pose of the second connected vehicle 120. Thus, when the second connected vehicle 120 needs to utilize sensing data received from the first connected vehicle 110, the data received from the second connected vehicle 120 needs to be transformed into a coordinate system of the first connected vehicle 110. In some embodiments, the first connected vehicle 110 and the second connected vehicle 120 may be driving in the same direction on the same road. The first connected vehicle 110 and the second connected vehicle 120 may drive in the same lane or in different lanes.

In embodiments, each of the first connected vehicle 110 and the second connected vehicle 120 has a set of sensors for detecting external objects. For example, each of the first connected vehicle 110 and the second connected vehicle 120 has a set of two different sensors from among cameras, LiDAR sensors, radar sensors, etc. In embodiments, each of the first connected vehicle 110 and the second connected vehicle 120 has one or more LiDAR sensors and a set of cameras. The first connected vehicle 110 obtains a point cloud using the one or more LiDAR sensors and images of different view of using the set of cameras. Then, the first connected vehicle 110 extracts features from the point cloud obtained by the one or more LiDAR sensors and extract features from the images obtained by the cameras and concatenates the features from the point cloud and the features from the images. Similarly, the second connected vehicle 120 obtains a point cloud using the one or more LiDAR sensors and images of different view of using the set of cameras. Then, the second connected vehicle 120 extracts features from the point cloud and extract features from the images and concatenates the features from the point cloud and the features from the images.

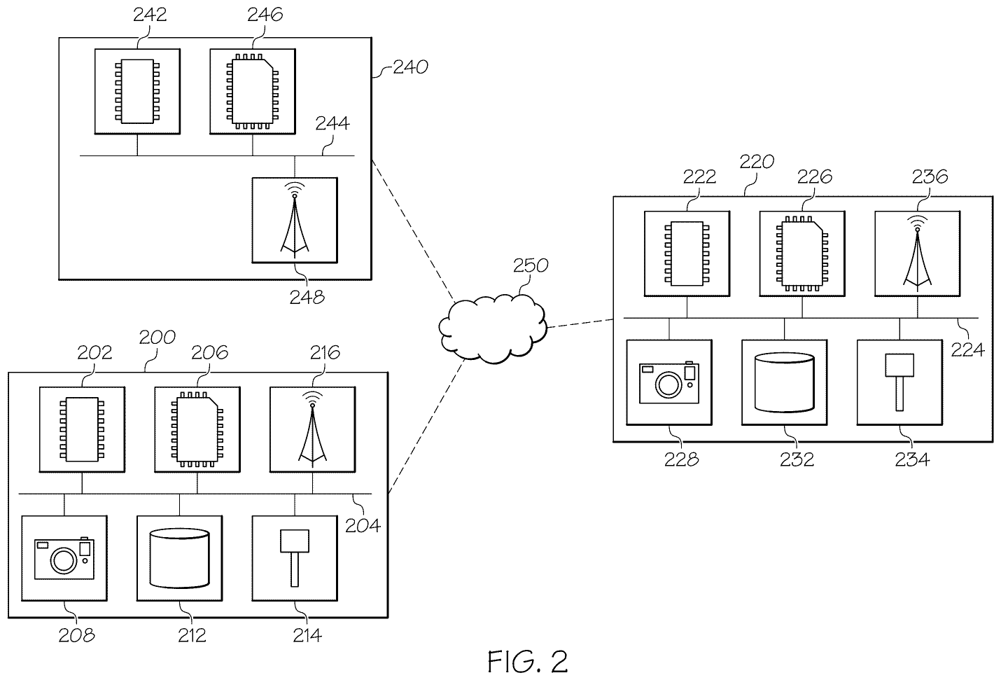

The second connected vehicle 120 transmits the concatenated multi-sensor features to the first connected vehicle 110, which fused its concatenated multi-sensor features with the concatenated multi-sensor features from the second connected vehicle 120. The first connected vehicle 110 decodes the fused data to identify external objects. The details of extracting features, concatenating features, and fusing the features will be described in detail with reference to FIGS. 2 through 6 below. While FIG. 1A illustrates two connected vehicles cooperatively capturing views, more than two connected vehicles may be involved for cooperative perceptions.

FIG. 1B illustrates difference between the data fusion of the present disclosure and the conventional data fusion. By referring to the early fusion on the left side of FIG. 1B, an ego vehicle receives raw sensing data from another vehicle, and processes the data to extract features and obtains predictions based on the extracted features. However, it is challenging to send the huge amount of raw sensing data in real time from one vehicle to another. By referring to the late fusion on the right side of FIG. 1B, an ego vehicle receives prediction results from another vehicle and combines the prediction results of the ego vehicle with the prediction results from another vehicle to obtain final results. For this type of sensor fusion system to benefit the ego vehicle, an object needs to be detected by either another vehicle or the ego vehicle, or both. However, in reality, the ego vehicle or another vehicle may not correctly predict identification of objects when the objects are blocked from the view of the ego vehicle or another vehicle. In contrast with the conventional data fusion, the present disclosure adopts intermediate fusion which shares intermediate features.

According to the present system, a remote vehicle transmits its features extracted from its raw sensing data to an ego vehicle, and the ego vehicle fuses the features of the ego vehicle and the features of the remote vehicle. Then, the ego vehicle obtains detection results based on the fused multi-sensor features. Because each vehicle routinely extracts features out of raw data locally and the features are intermediate produce of object detection networks, the present system does not require additional computation overhead. In addition, the present system does not require raw sensing data transmission, but retains information about raw data by communicating features. Thus, the present system provides good balance between detection accuracy and transmission bandwidth.

FIG. 2 schematically depicts a system for cooperative perception using intermediate fusion, according to one or more embodiments shown and described herein. The system for cooperative perception using intermediate fusion includes a first connected vehicle system 200 and a second connected vehicle system 220. In some embodiments, the system may also include a server 240.

It is noted that, while the first connected vehicle system 200 and the second connected vehicle system 220 are depicted in isolation, each of the first connected vehicle system 200 and the second connected vehicle system 220 may be included within a vehicle in some embodiments, for example, respectively within each of the first and second connected vehicles 110 and 120 of FIG. 1A. In embodiments in which each of the first connected vehicle system 200 and the second connected vehicle system 220 is included within a vehicle, the vehicle may be an automobile or any other passenger or non-passenger vehicle such as, for example, a terrestrial, aquatic, and/or airborne vehicle. In some embodiments, the vehicle is an autonomous vehicle that navigates its environment with limited human input or without human input.

The first connected vehicle system 200 includes one or more processors 202. Each of the one or more processors 202 may be any device capable of executing machine readable and executable instructions. Accordingly, each of the one or more processors 202 may be a controller, an integrated circuit, a microchip, a computer, or any other computing device. The one or more processors 202 are coupled to a communication path 204 that provides signal interconnectivity between various modules of the system. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as WiFi, Bluetooth®, Near Field Communication (NFC) and the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The first connected vehicle system 200 includes one or more memory modules 206 coupled to the communication path 204. The one or more memory modules 206 may comprise RAM, ROM, flash memories, hard drives, or any device capable of storing machine readable and executable instructions such that the machine readable and executable instructions can be accessed by the one or more processors 202. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 206. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

The one or more memory modules 206 may include machine readable instructions that, when executed by the one or more processors 202, cause the one or more processors 242 to obtain features for 3D data captured by one or more first sensors (e.g., a LiDAR sensor) of the first connected vehicle system 200, obtain features for images captured by second sensors (e.g., camera sensors) of the first connected vehicle system 200, flatten the features for 3D data to first features in bird eye view, transform the features for images into second features in bird eye view, concatenate the first features and the second features to obtain first concatenated multi-sensor features, and fuse the first concatenated multi-sensor features with second concatenated multi-sensor features received from another vehicle to obtain fused multi-sensor features.

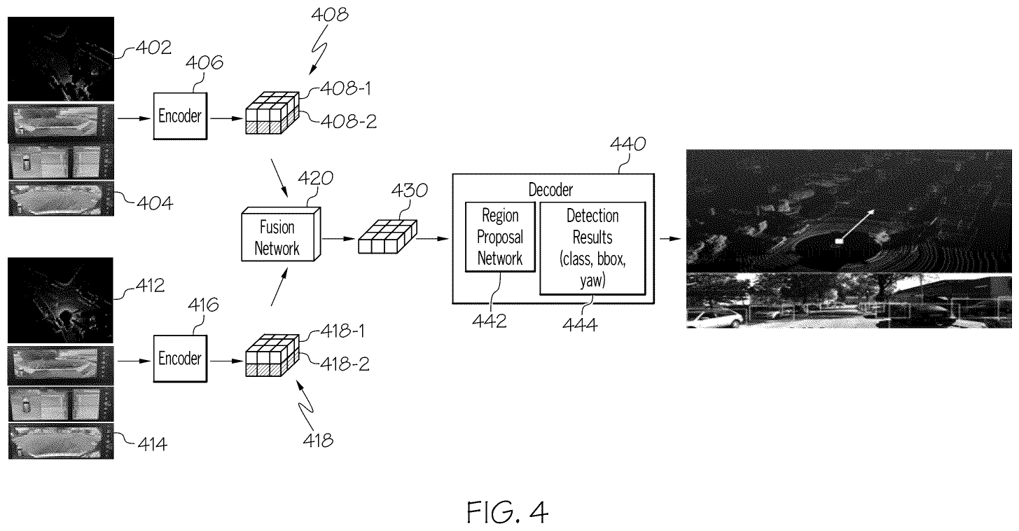

Referring still to FIG. 2, the first connected vehicle system 200 comprises one or more sensors 208 for detecting external objects. The one or more sensors includes, but not limited to, cameras, LiDAR sensors, radar sensors, and the like. The one or more sensors 208 may be any device having an array of sensing devices capable of detecting radiation in an ultraviolet wavelength band, a visible light wavelength band, or an infrared wavelength band. The one or more sensors 208 may have any resolution. In some embodiments, one or more optical components, such as a mirror, fish-eye lens, or any other type of lens may be optically coupled to the one or more sensors 208. In embodiments described herein, the one or more sensors 208 may provide image data such as point clouds and/or images to the one or more processors 202 or another component communicatively coupled to the communication path 204. For example, the image data may include image data of point clouds 402 and images 404 in FIG. 4. In some embodiments, the one or more sensors 208 may also provide navigation support. That is, data captured by the one or more sensors 208 may be used to autonomously or semi-autonomously navigate the connected vehicle 110.

In some embodiments, the one or more sensors 208 include one or more imaging sensors configured to operate in the visual and/or infrared spectrum to sense visual and/or infrared light. Additionally, while the particular embodiments described herein are described with respect to hardware for sensing light in the visual and/or infrared spectrum, it is to be understood that other types of sensors are contemplated. For example, the systems described herein could include one or more LiDAR sensors, radar sensors, sonar sensors, or other types of sensors and that such data could be integrated into or supplement the data collection described herein to develop a fuller real-time traffic image. Ranging sensors like radar may be used to obtain a rough depth and speed information for the view of the first connected vehicle system 200.

In operation, the one or more sensors 208 capture image data and communicate the image data to the one or more processors 202 and/or to other systems communicatively coupled to the communication path 204. The image data may be received by the one or more processors 202, which may process the image data using one or more image processing algorithms. Any known or yet-to-be developed video and image processing algorithms may be applied to the image data in order to identify an item or situation. Example video and image processing algorithms include, but are not limited to, kernel-based tracking (such as, for example, mean-shift tracking) and contour processing algorithms. In general, video and image processing algorithms may detect objects and movement from sequential or individual frames of image data. One or more object recognition algorithms may be applied to the image data to extract objects and determine their relative locations to each other. Any known or yet-to-be-developed object recognition algorithms may be used to extract the objects or even optical characters and images from the image data. Example object recognition algorithms include, but are not limited to, scale-invariant feature transform (“SIFT”), speeded up robust features (“SURF”), and edge-detection algorithms.

The first connected vehicle system 200 comprises a satellite antenna 214 coupled to the communication path 204 such that the communication path 204 communicatively couples the satellite antenna 214 to other modules of the first connected vehicle system 200. The satellite antenna 214 is configured to receive signals from global positioning system satellites. Specifically, in one embodiment, the satellite antenna 214 includes one or more conductive elements that interact with electromagnetic signals transmitted by global positioning system satellites. The received signal is transformed into a data signal indicative of the location (e.g., latitude and longitude) of the satellite antenna 214 or an object positioned near the satellite antenna 214, by the one or more processors 202.

The first connected vehicle system 200 comprises one or more vehicle sensors 212. Each of the one or more vehicle sensors 212 is coupled to the communication path 204 and communicatively coupled to the one or more processors 202. The one or more vehicle sensors 212 may include one or more motion sensors for detecting and measuring the orientation, motion and changes in motion of the vehicle. The motion sensors may include inertial measurement units. Each of the one or more motion sensors may include one or more accelerometers and one or more gyroscopes. Each of the one or more motion sensors transforms sensed physical movement of the vehicle into a signal indicative of an orientation, a rotation, a velocity, or an acceleration of the vehicle.

Still referring to FIG. 2, the first connected vehicle system 200 comprises network interface hardware 216 for communicatively coupling the first connected vehicle system 200 to the second connected vehicle system 220 and/or the server 240. The network interface hardware 216 can be communicatively coupled to the communication path 204 and can be any device capable of transmitting and/or receiving data via a network. Accordingly, the network interface hardware 216 can include a communication transceiver for sending and/or receiving any wired or wireless communication. For example, the network interface hardware 216 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 216 includes hardware configured to operate in accordance with the Bluetooth® wireless communication protocol. The network interface hardware 216 of the first connected vehicle system 200 may transmit its data to the server 240. For example, the network interface hardware 216 of the first connected vehicle system 200 may transmit captured point cloud generated by the first connected vehicle system 200, vehicle data, location data, and the like to other connected vehicles or the server 240.

The first connected vehicle system 200 may connect with one or more external vehicles and/or external processing devices (e.g., the server 240) via a direct connection. The direct connection may be a vehicle-to-vehicle connection (“V2V connection”) or a vehicle-to-everything connection (“V2X connection”). The V2V or V2X connection may be established using any suitable wireless communication protocols discussed above. A connection between vehicles may utilize sessions that are time-based and/or location-based. In embodiments, a connection between vehicles or between a vehicle and an infrastructure element may utilize one or more networks to connect (e.g., the network 250), which may be in lieu of, or in addition to, a direct connection (such as V2V or V2X) between the vehicles or between a vehicle and an infrastructure. By way of non-limiting example, vehicles may function as infrastructure nodes to form a mesh network and connect dynamically on an ad-hoc basis. In this way, vehicles may enter and/or leave the network at will, such that the mesh network may self-organize and self-modify over time. Other non-limiting network examples include vehicles forming peer-to-peer networks with other vehicles or utilizing centralized networks that rely upon certain vehicles and/or infrastructure elements. Still other examples include networks using centralized servers and other central computing devices to store and/or relay information between vehicles.

Still referring to FIG. 2, the first connected vehicle system 200 may be communicatively coupled to the server 240 by the network 250. In one embodiment, the network 250 may include one or more computer networks (e.g., a personal area network, a local area network, or a wide area network), cellular networks, satellite networks and/or a global positioning system and combinations thereof. Accordingly, the first connected vehicle system 200 can be communicatively coupled to the network 250 via a wide area network, via a local area network, via a personal area network, via a cellular network, via a satellite network, etc. Suitable local area networks may include wired Ethernet and/or wireless technologies such as, for example, wireless fidelity (Wi-Fi). Suitable personal area networks may include wireless technologies such as, for example, IrDA, Bluetooth®, Wireless USB, Z-Wave, ZigBee, and/or other near field communication protocols. Suitable cellular networks include, but are not limited to, technologies such as LTE, WiMAX, UMTS, CDMA, and GSM.

Still referring to FIG. 2, the second connected vehicle system 220 includes one or more processors 222, one or more memory modules 226, one or more sensors 228, one or more vehicle sensors 232, a satellite antenna 234, network interface hardware 236, and a communication path 224 communicatively connected to the other components of the second connected vehicle system 220. The components of the second connected vehicle system 220 may be structurally similar to and have similar functions as the corresponding components of the first connected vehicle system 200 (e.g., the one or more processors 222 corresponds to the one or more processors 202, the one or more memory modules 226 corresponds to the one or more memory modules 206, the one or more sensors 228 corresponds to the one or more sensors 208, the one or more vehicle sensors 232 corresponds to the one or more vehicle sensors 212, the satellite antenna 234 corresponds to the satellite antenna 214, the network interface hardware 236 corresponds to the network interface hardware 216, and the communication path 224 corresponds to the communication path 204).

In embodiments, the one or more memory modules 226 may include machine readable instructions that, when executed by the one or more processors 222, cause the one or more processors 242 to obtain features for 3D data captured by a third sensor (e.g., a LiDAR sensor) of the second connected vehicle system 220, obtain features for images captured by fourth sensors (e.g., camera sensors) of the second connected vehicle system 220, flatten the features for 3D data to third features in bird eye view, transform the features for images into fourth features in bird eye view, concatenate the third features and the fourth features to obtain second concatenated multi-sensor features, and fuse the first concatenated multi-sensor features with second concatenated multi-sensor features received from another vehicle to obtain fused multi-sensor features. The second connected vehicle system 220 may transmit the fused multi-sensor features to the first connected vehicle system 200.

Still referring to FIG. 2, the server 240 includes one or more processors 242, one or more memory modules 246, network interface hardware 248, and a communication path 244. The one or more processors 242 may be a controller, an integrated circuit, a microchip, a computer, or any other computing device. The one or more memory modules 246 may comprise RAM, ROM, flash memories, hard drives, or any device capable of storing machine readable and executable instructions such that the machine readable and executable instructions can be accessed by the one or more processors 242. The communication path 244 may be similar to the communication path 204 in some embodiments.

In some embodiments, the server 240 may receive features from the first connected vehicle system 200 and the second connected vehicle system 220, fuses the features, and transmit the fused multi-sensor features to the first connected vehicle system 200 and the second connected vehicle system 220. Specifically, the one or more memory modules 246 may include machine readable instructions that, when executed by the one or more processors 242, cause the one or more processors 242 to obtain features for 3D data captured by one or more first sensors (e.g., a LiDAR sensor) of the first connected vehicle system 200, obtain features for images captured by second sensors (e.g., camera sensors) of the first connected vehicle system 200, flatten the features for 3D data to first features in bird eye view, transform the features for images into second features in bird eye view, and concatenate the first features and the second features to obtain first concatenated multi-sensor features. In addition, the one or more memory modules 246 may include machine readable instructions that, when executed by the one or more processors 242, cause the one or more processors 242 to obtain features for 3D data captured by a third sensor (e.g., a LiDAR sensor) of the second connected vehicle system 220, obtain features for images captured by fourth sensors (e.g., camera sensors) of the second connected vehicle system 220, flatten the features for 3D data to third features in bird eye view, transform the features for images into fourth features in bird eye view, concatenate the third features and the fourth features to obtain second concatenated multi-sensor features, and fuse the first concatenated multi-sensor features with second concatenated multi-sensor features to obtain fused multi-sensor features. The server 240 may transmit the fused multi-sensor features to the first connected vehicle system 200 and the second connected vehicle system 220.

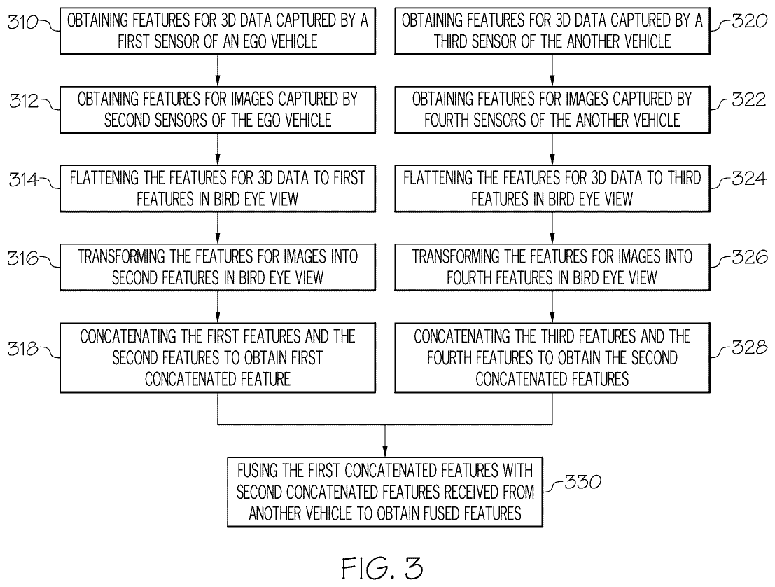

FIG. 3 depicts an overall process for fusing features from a plurality of vehicles, according to one or more embodiments shown and described herein.

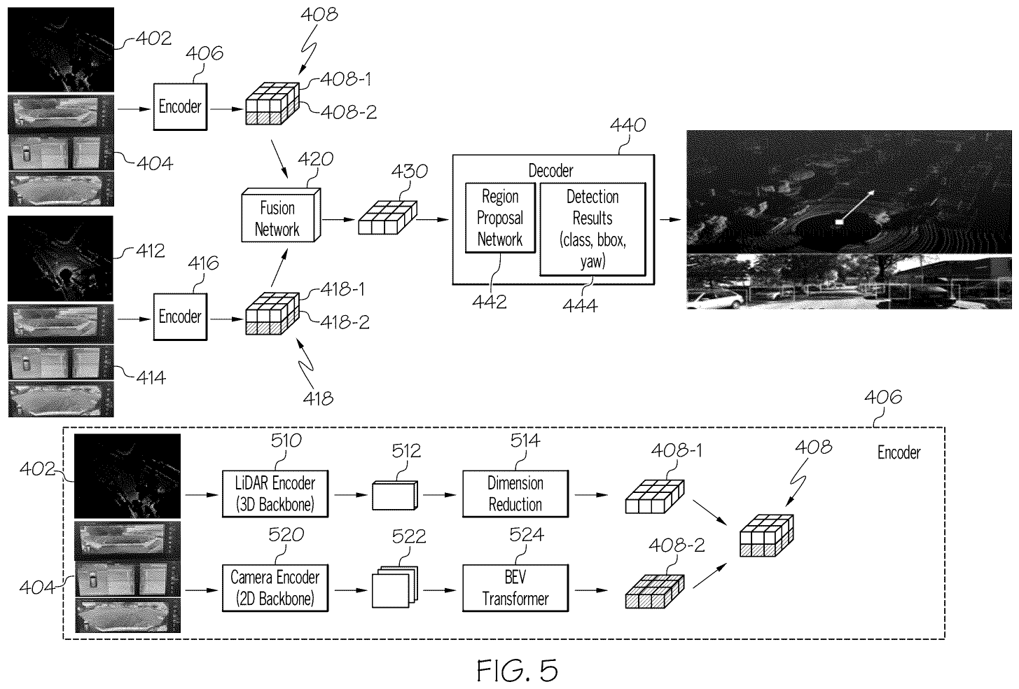

In step 310, the present system obtains features for 3D data captured by a first sensor of an ego vehicle. In embodiments, by referring to FIGS. 2, 4, and 5, the first connected vehicle system 200 of the ego vehicle may obtain capture 3D data such as the point cloud 402 using one or more LiDAR sensors. Then, the first connected vehicle system 200 obtains features for the 3D data, e.g., by extracting the features from the point cloud 402. By referring to FIG. 5, the encoder 406 of the first connected vehicle system 200 may extract the features from the point cloud 402. Features may be information about the content of an image including, but not limited to, points, edges, or objects. The encoder 406 may include a plurality of encoders, for example, a LiDAR encoder 510 for extracting features from point clouds and a camera encoder 520 for extracting features from images. The LiDAR encoder 510 receives the LiDAR point clouds 402 as input and outputs features 512 related to 3D LiDAR point clouds.

Referring back to FIG. 3, in step 312, the present system obtains features for images captured by second sensors of the ego vehicle. In embodiments, by referring to FIGS. 2, 4, and 5, the first connected vehicle system 200 of the ego vehicle may obtain images of different views such as the images 404 using a plurality of cameras. For example, the plurality of cameras are placed on the ego vehicle and oriented in different directions such that different external views of the ego vehicle may be captured. The images may include a front view image, a rear view image, a left view image, and a right view image such that the images may be combined to constitute a bird-eye-view image. Then, the first connected vehicle system 200 obtains features for the images, e.g., by extracting the features from the images 404. By referring to FIG. 5, the encoder 406 of the first connected vehicle system 200 may extract the features from the images 404. Features may be information about the content of an image including, but not limited to, points, edges, or objects. The encoder 406 may include a camera encoder 520. The camera encoder 520 receives multi-view RGB images such as the images 404 as input and outputs camera features 522 related to multi-view RGB images.

Referring back to FIG. 3, in step 314, the present system flattens the features for 3D data to first features in bird eye view. In embodiments, the first connected vehicle system 200 may flatten features for 3D data to features in bird eye view. By referring to FIGS. 2, 4, and 5, the dimension reduction module 514 may flatten features 512 related to the 3D LiDAR point clouds and outputs the first features 408-1 in bird eye view.

Referring back to FIG. 3, in step 316, the present system transforms the features for images into second features in bird eye view. In embodiments, the first connected vehicle system 200 may transform the features for images into second features in bird eye view. By referring to FIGS. 2, 4, and 5, the bird-eye-view transformer 524 transforms the features 522 related to multi-view RGB images to output the second features 408-2 in bird eye view.

Referring back to FIG. 3, in step 318, the present system concatenates the first features and the second features to obtain first concatenated feature. In embodiments, by referring to FIG. 5, the first connected vehicle system 200 concatenates the first features 408-1 and the second features 408-2 to obtain the first concatenated multi-sensor features 408.

Referring back to FIG. 3, in parallel with steps 310 through 318, steps 320 through 328 may be performed. In step 320, the present system obtains features for 3D data captured by a third sensor of another vehicle. In embodiments, by referring to FIGS. 2, 4, and 5, the second connected vehicle system 220 of another vehicle may obtain capture 3D data such as the point cloud 412 using a LiDAR sensor. Then, the second connected vehicle system 220 obtains features for the 3D data, e.g., by extracting the features from the point cloud 412. By referring to FIG. 5, the encoder 416 of the second connected vehicle system 220 may extract the features from the point cloud 412. Features may be information about the content of an image including, but not limited to, points, edges, or objects. The encoder 416 may include a plurality of encoders, for example, a LiDAR encoder for extracting features from point clouds similar to the LiDAR encoder 510 and a camera encoder for extracting features from images similar to the camera encoder 520. The LiDAR encoder receives the LiDAR point clouds 412 as input and outputs features related to 3D LiDAR point clouds.

Referring back to FIG. 3, in step 322, the present system obtains features for images captured by fourth sensors of the ego vehicle. In embodiments, by referring to FIGS. 2, 4, and 5, the second connected vehicle system 220 of another vehicle may obtain images of different views such as the images 414 using a plurality of cameras. For example, the plurality of cameras are placed on another vehicle and oriented in different directions such that different external views of another vehicle may be captured. The images may include a front view image, a rear view image, a left view image, and a right view image such that the images may be combined to constitute a bird-eye-view image. Then, the second connected vehicle system 220 obtains features for the images, e.g., by extracting the features from the images 414. By referring to FIG. 5, the encoder of the second connected vehicle system 220 may extract the features from the images 414. Features may be information about the content of an image including, but not limited to, points, edges, or objects. The encoder 416 may include a camera encoder. The camera encoder receives multi-view RGB images as input and outputs camera features related to multi-view RGB images.

Referring back to FIG. 3, in step 324, the present system flattens the features for 3D data to third features in bird eye view. In embodiments, the second connected vehicle system 220 may flatten features for 3D data to features in bird eye view. By referring to FIGS. 2, 4, and 5, a dimension reduction module of the encoder 416 similar to the dimension reduction module 514 may flatten features related to the 3D LiDAR point clouds and output the third features 418-1 in bird eye view.

Referring back to FIG. 3, in step 326, the present system transforms the features for images into fourth features in bird eye view. In embodiments, the second connected vehicle system 220 may transform the features for images into fourth features in bird eye view. By referring to FIGS. 2, 4, and 5, a bird-eye-view transformer of the encoder 416 similar to the bird-eye-view transformer 524 transforms the features related to multi-view RGB images to output the fourth features 418-2 in bird eye view.

Referring back to FIG. 3, in step 328, the present system concatenates the third features and the fourth features to obtain second concatenated feature. In embodiments, by referring to FIG. 5, the second connected vehicle system 220 concatenates the third features 418-1 and the fourth features 418-2 to obtain the second concatenated multi-sensor features 418.

Referring back to FIG. 3, in step 330, the present system fuses the first concatenated multi-sensor features with second concatenated multi-sensor features received from another vehicle to obtain fused multi-sensor features. By referring to FIG. 4, a fusion network 420 fuses the first concatenated multi-sensor features 408 and the second concatenated multi-sensor features 418 to obtain fused multi-sensor features 430. In embodiments, the fusion network 420 may be in the first connected vehicle system 200. In another embodiment, the fusion network 420 may be in the second connected vehicle system 220. In some embodiments, the fusion network 420 may be in the server 240. The details of fusing features will be described below with reference to FIG. 6.

FIG. 4 depicts the overall process of fusing features of multi-modal sensors. A first connected vehicle, or an ego vehicle, obtains a point cloud 402 using a LiDAR sensor and multi-view images 404 using a plurality of cameras. Then, the encoder 406 of the first connected vehicle outputs the first concatenated multi-sensor features 408 that includes features 408-1 derived from the point cloud 402 and the features 408-2 derived from the multi-view images 404. Similarly, a second connected vehicle, or another vehicle, obtains a point cloud 412 using a LiDAR sensor and multi-view images 414 using a plurality of cameras. Then, the encoder 416 of the second connected vehicle outputs the second concatenated multi-sensor features 418 that includes features 418-1 derived from the point cloud 412 and the features 418-2 derived from the multi-view images 414. The fusion network 420 fuses the first concatenated multi-sensor features 408 and the second concatenated multi-sensor features 418 to obtain fused multi-sensor features 430.

The decoder 440 then decodes the fused multi-sensor features 430 to identify external objects. The decoder 440 includes a region proposal network 442. The region proposal network 442 includes a fully convolutional network that simultaneously predicts object bounds and objectness scores at each position. The region proposal network 442 outputs detection results 444. The detection results 444 include, but not limited to, class information, bounding boxes for objects, yaw rates of object, and the like.

FIG. 5 depicts details of an encoder that is used by an ego vehicle and another vehicle, according to one or more embodiments shown and described herein. In embodiments, the encoder 406 of the first connected vehicle system 200 may include a LiDAR encoder 510 and a camera encoder 520. The LiDAR encoder 510 encodes the LiDAR point cloud 402 to extract features 512, which are then flattened by the dimension reduction module 514 to the first features 408-1. The camera encoder 520 encodes the multi-view images 404 to extract features 522, which are then transformed by the bird-eye-view transformer 524 to the second features 408-2. The first features 408-1 and the second features 408-2 are then concatenated to obtain the first concatenated multi-sensor features 408. The encoder 416 of the second connected vehicle system 220 may have similar components as the encoder 406 and output the second concatenated multi-sensor features 418.

FIG. 6 depicts details of fusing two concatenated multi-sensor features by a fusion network, according to one or more embodiments shown and described herein. In embodiments, the fusion network 420 receives the concatenated multi-sensor features 408 of an ego vehicle such as the first connected vehicle 110 in FIG. 1A and the concatenated multi-sensor features 418 of a remote vehicle such as the second connected vehicle 120 in FIG. 1B as inputs.

The second concatenated multi-sensor features 418 of the remote vehicle may be aligned with the first concatenated multi-sensor features 408 of the ego vehicle based on the coordinates and orientation of the ego vehicle. The second concatenated multi-sensor features 418 of the remote vehicle are down sampled into a squeeze map 610. The squeeze map 610 is processed via FC1, ReLU, FC2, and Sigmod to output a scale 612 that represents relative importance of the concatenated multi-sensor features 418 of the remote vehicle. Then, the concatenated multi-sensor features 408 of the ego vehicle are multiplied by the scale 612 to generate a scaled feature map of the ego vehicle. The scaled feature map of the ego vehicle is combined with the concatenated multi-sensor features of the remote vehicle to generate the fused multi-sensor features.

It should be understood that embodiments described herein are directed to methods and systems for fusing multi-modal sensor data. The present method includes obtaining features for 3D data captured by a first sensor of an ego vehicle, obtaining features for images captured by second sensors of the ego vehicle, flattening the features for 3D data to first features in bird eye view, transforming the features for images into second features in bird eye view, concatenating the first features and the second features to obtain first concatenated multi-sensor features, and fusing the first concatenated multi-sensor features with second concatenated multi-sensor features received from another vehicle to obtain fused multi-sensor features.

The present disclosure utilizes feature-based collaboration. According to the present system, a remote vehicle transmits its features extracted from its raw sensing data to an ego vehicle, and the ego vehicle fuses the features of the ego vehicle and the features of the remote vehicle. The scale-fusion network of the present system allows the network to fuse better features shared by surrounding vehicles with the ego vehicle's local features. The superior performance comes from the careful design in the architecture of scale-fusion.

The ego vehicle obtains detection results based on the fused multi-sensor features. Because each vehicle routinely extracts features out of raw data locally and the features are intermediate produce of object detection networks, the present system does not require additional computation overhead. In addition, the present system does not require raw sensing data transmission, but retains information about raw data by communicating features. Thus, the present system provides good balance between detection accuracy and transmission bandwidth.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method of fusing multi-modal sensor data, the method comprising:
obtaining features for 3D data captured by a first sensor of an ego vehicle;
obtaining features for images captured by second sensors of the ego vehicle;
flattening the features for 3D data to first features in bird eye view;
transforming the features for images into second features in bird eye view;
concatenating the first features and the second features to obtain first concatenated multi-sensor features; and
fusing the first concatenated multi-sensor features with second concatenated multi-sensor features received from another vehicle to obtain fused multi-sensor features.

2. The method of claim 1, further comprising:
obtaining features for 3D data captured by a third sensor of the another vehicle;
obtaining features for images captured by fourth sensors of the another vehicle;
flattening the features for 3D data to third features in bird eye view;
transforming the features for images into fourth features in bird eye view; and
concatenating the third features and the fourth features to obtain the second concatenated multi-sensor features.

3. The method of claim 1, further comprising:
decoding the fused multi-sensor features to identify objects external to the ego vehicle; and
operating the ego vehicle based on the identified object.

4. The method of claim 2, wherein the first sensor and the third sensor are LiDAR sensors and the second sensors and the fourth sensors are camera sensors.

5. The method of claim 1, wherein:
the 3D data is a 3D LiDAR point cloud; and
the features for the 3D data are obtained by inputting the 3D LiDAR point cloud into a LiDAR encoder.

6. The method of claim 1, wherein:
the images are RGB images captured by cameras oriented in different directions; and
the features for the images are obtained by inputting the RGB images into a camera encoder.

7. The method of claim 1, wherein the fusing the first concatenated multi-sensor features with the second concatenated multi-sensor features comprises:
obtaining a scaled feature map of the ego vehicle based on the first concatenated multi-sensor features and the second concatenated multi-sensor features; and
combining the scaled feature map of the ego vehicle with the second concatenated multi-sensor features to obtain the fused multi-sensor features.

8. The method of claim 7, wherein the obtaining the scaled feature map of the ego vehicle comprises:
down-sampling the second concatenated multi-sensor features into a one-dimensional squeeze map;
processing the one-dimensional squeeze map to obtain a one-dimensional scale; and
multiplying the first concatenated multi-sensor features with the one-dimensional scale to obtain the scaled feature map of the ego vehicle.

9. The method of claim 1, wherein the ego vehicle and the another vehicle are connected autonomous vehicles.

10. The method of claim 2, wherein the first sensor and the third sensor are radar sensors and the second sensors and the fourth sensors are camera sensors.

11. A system for fusing multi-modal sensor data, the system comprising:
a vehicle comprising a processor programmed to perform:
obtaining features for 3D data captured by a first sensor of an ego vehicle;
obtaining features for images captured by second sensors of the ego vehicle;
flattening the features for 3D data to first features in bird eye view;
transforming the features for images into second features in bird eye view;
concatenating the first features and the second features to obtain first concatenated multi-sensor features; and
fusing the first concatenated multi-sensor features with second concatenated multi-sensor features received from another vehicle to obtain fused multi-sensor features.

12. The system of claim 11, further comprising:
another vehicle comprising a processor programmed to perform:
obtaining features for 3D data captured by a third sensor of the another vehicle;
obtaining features for images captured by fourth sensors of the another vehicle;
flattening the features for 3D data to third features in bird eye view;
transforming the features for images into fourth features in bird eye view; and
concatenating the third features and the fourth features to obtain the second concatenated multi-sensor features.

13. The system of claim 11, wherein the processor is programmed to further perform:
decoding the fused multi-sensor features to identify objects external to the ego vehicle; and
operating the ego vehicle based on the identified object.

14. The system of claim 12, wherein the first sensor and the third sensor are LiDAR sensors and the second sensors and the fourth sensors are camera sensors.

15. The system of claim 11, wherein:
the 3D data is a 3D LiDAR point cloud; and
the features for the 3D data are obtained by inputting the 3D LiDAR point cloud into a LiDAR encoder.

16. The system of claim 11, wherein:
the images are RGB images captured by cameras oriented in different directions; and
the features for the images are obtained by inputting the RGB images into a camera encoder.

17. The system of claim 11, wherein the fusing the first concatenated multi-sensor features with the second concatenated multi-sensor features comprises:
obtaining a scaled feature map of the ego vehicle based on the first concatenated multi-sensor features and the second concatenated multi-sensor features; and
combining the scaled feature map of the ego vehicle with the second concatenated multi-sensor features to obtain the fused multi-sensor features.

18. The system of claim 17, wherein the obtaining the scaled feature map of the ego vehicle comprises:
down-sampling the second concatenated multi-sensor features into a one-dimensional squeeze map;
processing the one-dimensional squeeze map to obtain a one-dimensional scale; and
multiplying the first concatenated multi-sensor features with the one-dimensional scale to obtain the scaled feature map of the ego vehicle.

19. The system of claim 12, wherein the first sensor and the third sensor are radar sensors and the second sensors and the fourth sensors are camera sensors.

20. A non-transitory computer readable medium storing instructions, when executed by a processor, causing the processor to perform:
obtaining features for 3D data captured by a first sensor of an ego vehicle;
obtaining features for images captured by second sensors of the ego vehicle;
flattening the features for 3D data to first features in bird eye view;
transforming the features for images into second features in bird eye view;
concatenating the first features and the second features to obtain first concatenated multi-sensor features; and
fusing the first concatenated multi-sensor features with second concatenated multi-sensor features received from another vehicle to obtain fused multi-sensor features.
